(19) United States
(12) Patent Application Publication
(10) Pub. No.: US 2014/0088925 A1
(43) Pub. Date: Mar. 27, 2014

(54) SYSTEMS AND METHODS FOR COMPUTING SOLUTIONS OF GEOMETRIC CONSTRAINT EQUATIONS OF COMPUTER-IMPLEMENTED VIRTUAL MODELS

(71) Applicant: SIEMENS PRODUCT LIFECYCLE MANAGEMENT SOFTWARE, Plano, TX (US)

(72) Inventor: John Caradog Owen, Cambridge (GB)

(73) Assignee: SIEMENS PRODUCT LIFECYCLE MANAGEMENT SOFTWARE INC., Plano, TX (US)

(21) Appl. No.: 13/627,051

(22) Filed: Sep. 26, 2012

(51) Int. Cl. G06F 17/50

(52) U.S. Cl. 703/1

(57) ABSTRACT

Various disclosed embodiments include systems and methods for computing solutions of geometric constraint equations of computer-implemented virtual models. According to disclosed embodiments, a data processing system includes at least one processor and a memory connected to the processor. The data processing system is configured to receive geometric constraint equations of a virtual model and to decompose the geometric constraint equations into first and second subsets, wherein the first subset possesses consistent solutions and wherein the second subset lacks consistent solutions. The data processing system is configured to compute consistent solutions of the first subset and to compute approximate numerical solutions of the second subset by applying a numerical approximation algorithm to the second subset. The data processing system is configured to store the consistent and numerical solutions in a storage device connected to the processor.

### TECHNICAL FIELD

The present disclosure is directed, in general, to computer-aided design, visualization, and manufacturing systems, product lifecycle management (“PLM”) systems, and similar systems, that manage data for products and other items (collectively, “Product Data Management” systems or “PDM” systems).

### BACKGROUND OF THE DISCLOSURE

PDM systems manage PLM and other data. Improved systems are desirable.

### SUMMARY OF THE DISCLOSURE

Various disclosed embodiments include systems and methods for computing solutions of geometric constraint equations of computer-implemented virtual models. According to disclosed embodiments, a data processing system includes at least one processor and a memory connected to the processor. The data processing system is configured to receive geometric constraint equations of a virtual model and to decompose the geometric constraint equations into a plurality of first and second subsets, wherein the first subset possesses consistent solutions and wherein the second subset lacks consistent solutions. The data processing system is configured to compute consistent solutions of the first subset and to compute approximate numerical solutions of the second subset by applying numerical methods to the second subset.

According to disclosed embodiments, a method for computing solutions of geometric constraint equations of a computer-implemented virtual model includes receiving the geometric constraint equations of the virtual model and decomposing the geometric constraint equations into a plurality of first and second subsets of the geometric constraint equations, wherein the first subset possesses consistent solutions and wherein the second subset lacks consistent solutions. The method includes computing the consistent solutions of the first subset and computing approximate numerical solutions of the second subset by applying numerical methods to the second subset.

According to disclosed embodiments, a non-transitory computer-readable medium is encoded with computer-executable instructions for computing solutions of geometric constraint equations of a computer-implemented virtual model. The computer-executable instructions when executed cause at least one data processing system to: receive geometric constraint equations of the virtual model; decompose the geometric constraint equations into a plurality of first and second subsets, wherein the first subset possesses consistent solutions and wherein the second subset lacks consistent solutions; compute the consistent solutions of the first subset; and compute approximate numerical solutions of the second subset by applying numerical methods to the second subset.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system according to disclosed embodiments;

FIG. 2 illustrates a system according to disclosed embodiments;

FIGS. 3-6 illustrate use and operation of a system according to disclosed embodiments;

FIG. 7 is a flowchart of a process according to disclosed embodiments;

FIG. 8 is a flowchart of a process according to disclosed embodiments; and

FIG. 9 illustrates a cloud computing system according to disclosed embodiments.

### DETAILED DESCRIPTION

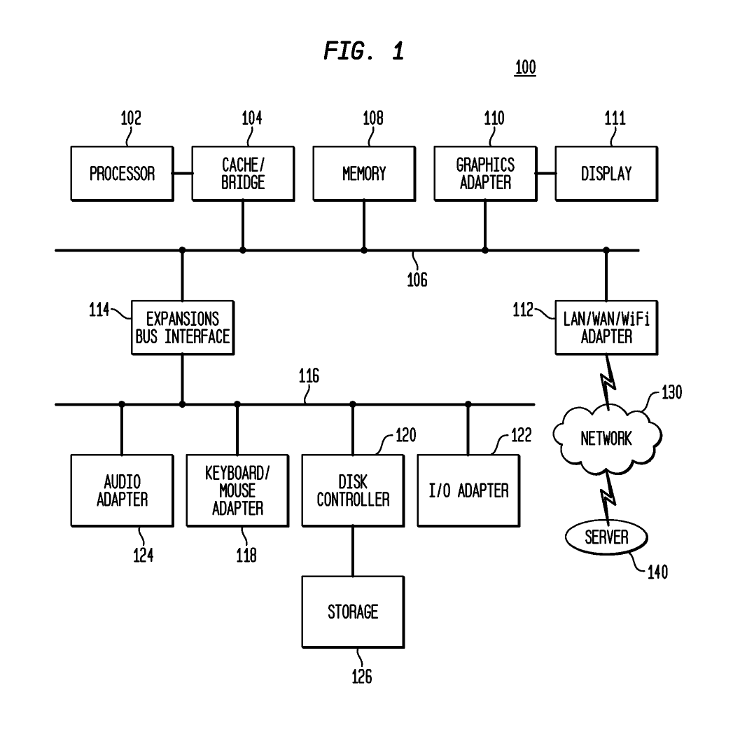

FIGS. 1 through 9, discussed below, and the various embodiments used to describe the principles of the present disclosure in this patent document are by way of illustration only and should not be construed in any way to limit the scope of the disclosure. Those skilled in the art will recognize that the principles of the present disclosure may be implemented in any suitably arranged device or a system. The numerous innovative teachings of the present disclosure will be described with reference to exemplary non-limiting embodiments

PDM systems are widely used in design and modification of virtual models. PDM systems allow designers to develop virtual models in a virtual environment. Currently available systems, for example, decompose geometric constraint equations of a virtual model into a plurality of subsets. The geometric constraint equations determine geometric elements of the virtual model. Currently available systems generally attempt to find a consistent solution for the geometric constraint equations in the subsets using either algebraic methods or numerical solution methods. If a consistent solution, which provides an exact consistent solution to each of the geometric constraint equations in the subset, cannot be found for one or more subsets, currently available systems typically do not make any modifications to the geometric elements of the virtual model which are in those subsets. Rather, an error may be flagged indicating that exact consistent solutions cannot be computed for one or more subsets.

Various disclosed embodiments provide systems and methods for computing solutions of geometric constraint equations of computer-implemented virtual models. More specifically, the disclosed embodiments provide solutions to equations when values specified by dimensions and/or geometric elements of a computer-implemented virtual model are not consistent with exact solutions. According to disclosed embodiments, geometric constraint equations of a virtual model are decomposed into a first subset for which algebraic solutions exists and a second subset which lacks exact algebraic solutions. Exact solutions of the first subset are computed algebraically. Then, approximate solutions of the second subset are computed using numerical method techniques. According to embodiments, the approximate solutions of the second subset are computed by minimizing least squares of the second subset.

FIG. 1 depicts a block diagram of data processing system 100 in which an embodiment can be implemented, for example as a PDM system particularly configured by software or otherwise to perform the processes as described herein, and in particular as each one of a plurality of interconnected and communicating systems as described herein. The data processing system depicted includes processor 102 connected to level two cache/bridge 104, which is connected in turn to local system bus 106. Local system bus 106 may be, for example, a peripheral component interconnect (PCI) architecture bus. Also connected to local system bus in the depicted example are main memory 108 and graphics adapter 110. Graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

Data processing system 100 in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100. Data processing system 100 may be configured as a workstation, and a plurality of similar workstations may be linked via a communication network to form a distributed system in accordance with embodiments of the disclosure.

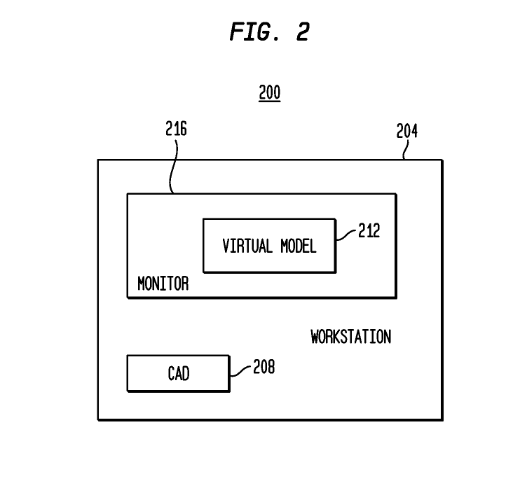

FIG. 2 illustrates PDM system 200 according to disclosed embodiments. PDM system 200 comprises computer workstation 204 including CAD application 208. Workstation 204 may be implemented by data processing system 100 as described above. A user may utilize CAD application 208 to create virtual model 212, which may be graphically displayed on monitor 216 connected to workstation 204. According to disclosed embodiments, CAD application 208 may include computer-executable instructions for computing solutions of geometric constraint equations of virtual model 212.

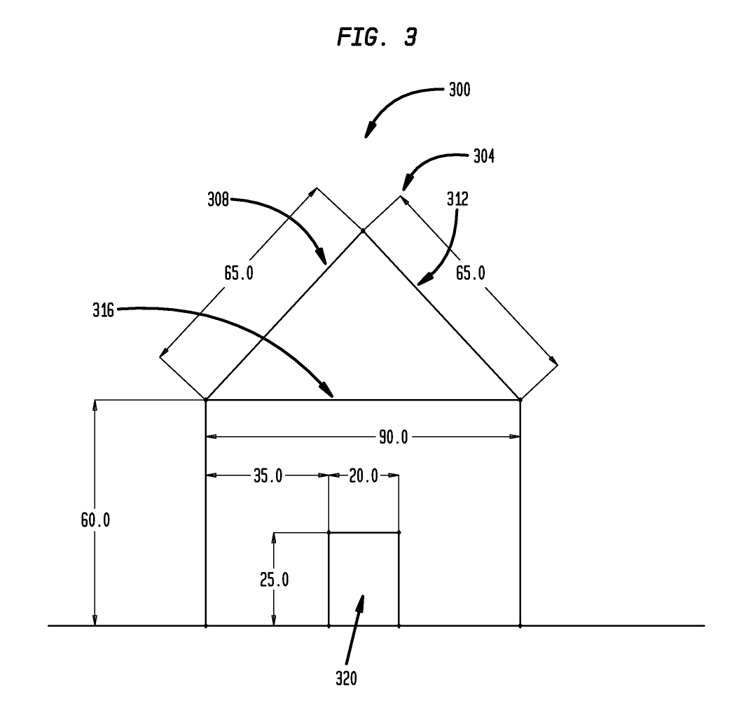

FIG. 3 illustrates a drawing of a front profile of house 300 created using PDM system 200 according to disclosed embodiments. House 300 has roof 304 having side lengths 308 and 312, and width 316. House 300 may be defined by a geometric constraint model comprising: (1) a set of eighteen geometric elements (nine points and nine lines); (2) a set of constraints (such as, point-lies-on-line or line-is-perpendicular-to-line); and (3) a set of dimensions (such as, distance between two points). The dimensions typically have values such as, for example, 20, 25, 35, 60, 65, and 90 in house 300. The geometric constraint model allows a user to input new values for the dimensions and to compute a new drawing.

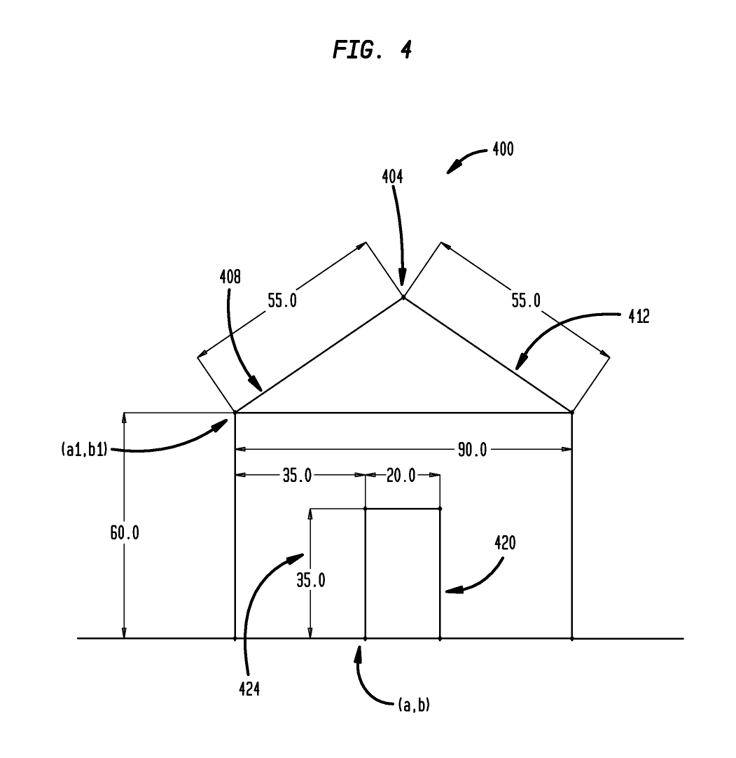

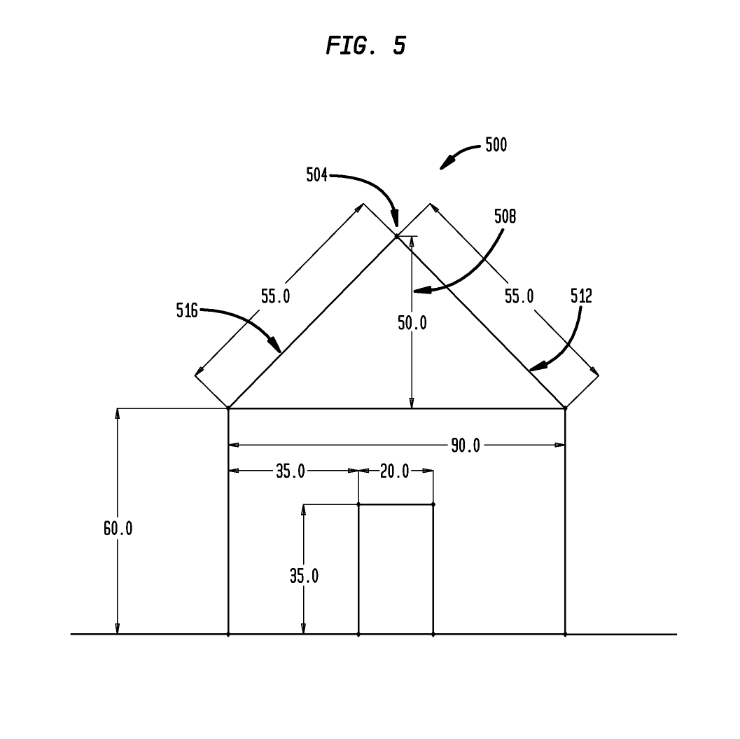

FIG. 4 shows house 400, which is created by modifying some of the dimensions of house 300. Specifically, in FIG. 4 the values for the lengths of the sloping roof sides 404 and 408 have been changed from 65 to 55 and height 412 of door 420 has been changed from 25 to 35. According to currently available systems, the dimension values must be such that all of the specified values can be achieved together. FIG. 5 shows an additional constraint which requires height 508 of roof 504 to have a value 50. However, this additional constraint (i.e., height of the roof to be 50) is not consistent with the width of the house and the lengths of the sloping sides 512 and 516 of roof 504. In this case, currently available systems may indicate that there is a conflict between the four dimensions with values 50, 55, 55, and 90 and thus a solution cannot be found. However there is still a solution for the door with the new height of 35.

Referring to FIG. 3, since the size of door 320 is independent from the size of roof 304, the geometric constraint model can be decomposed into smaller pieces consisting of door 320 and roof 304. The geometry for door 320 and roof 304 can be computed independently and then put into the correct position to create the final drawing.

Referring to FIG. 4, the geometric elements for roof 404 and door 420 in house 400 can be computed algebraically (i.e., using only the operations of addition, subtraction and square roots). For example the geometry for door 420 is computed by assigning the coordinates of one corner point the values (a, b) and then the remaining three corners are assigned coordinates (a+20, b), (a+20, b+35) and (a, b+35). The geometry of roof 404 is computed by assigning the three points the coordinates (a1, b1), (a1+90, b1) and (a1+90/2, b1+sqrt(55*55−90/2*90/2)). This results in dimensions such as the height 424 of the door 420.

FIG. 5 illustrates house 500 with roof 504 including height 508 and side lengths 512 and 516. The desired dimension values for roof 504 are as follows: height 508=50.0; side lengths 512, 516=55.0, 55.0. According to currently available systems, the size of roof 504 cannot be computed consistently because there are no positions for the points and lines in the roof which exactly satisfy the desired dimension values.

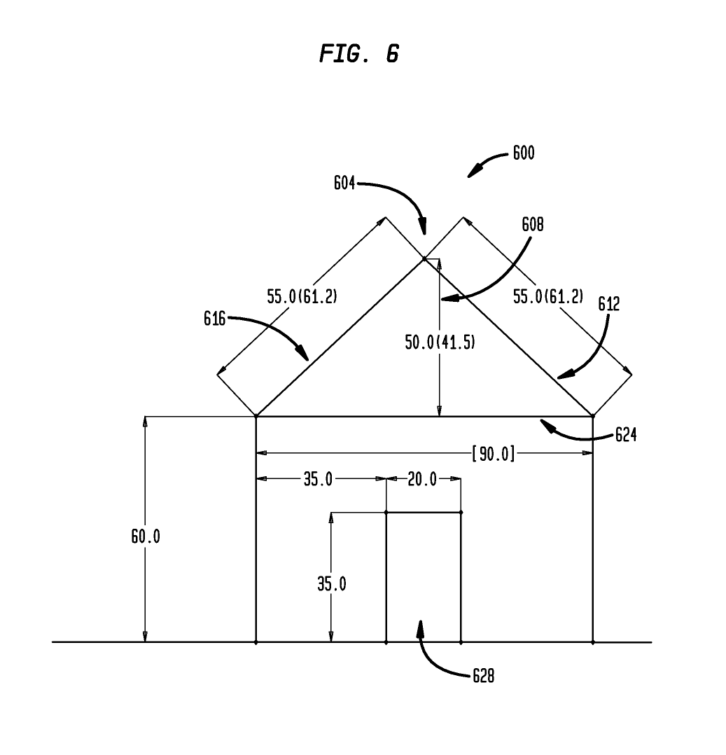

FIG. 6 shows house 600 with roof 604 including height 608 and side lengths 612 and 616. According to disclosed embodiments, height 608 and side lengths 612 and 616 of roof 604 are computed using a numerical least squares minimization algorithm. The numerical least squares algorithm computes compromise values for height 608 and side lengths 612 and 616 of roof 604 such that the sum of the squares of the deviations from the desired values is minimised. FIG. 6 shows both the desired values and the values which are actually achieved. By way of example, the desired values of roof 604 are as follows: height 608=50.0; side lengths 612 and 616=55.0 and 55.0. According to disclosed embodiments, actual achievable values are as follows: height 608=41.5; side lengths 612 and 616=61.2 and 61.2.

It will be appreciated that width 624 of roof 604 also determines the width of house 600. According to disclosed embodiments, a user may specify that the desired value 90 of width 624 should be satisfied exactly and not included in the least squares minimization. The height and width of door 628 can be computed algebraically,

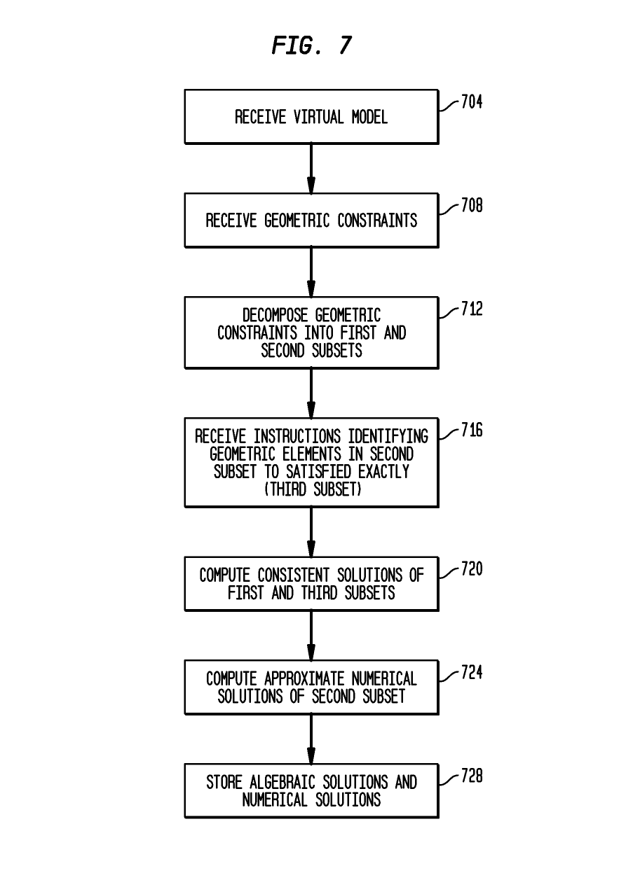

FIG. 7 is a flowchart of a process according to disclosed embodiments. Such a process can be performed, for example, by system 200 as described above, but the “system” in the process below can be any apparatus configured to perform a process as described. In block 704, system 200 receives a virtual model. In block 708, system 200 receives geometric constraint equations of the virtual model. By way of example, the geometric constraint equations of the virtual model may be generated by a CAD application.

In block 712, system 200 decomposes the geometric constraint equations into a plurality of first and second subsets of the geometric constraint equations. The first subset possesses consistent solutions but the second subset lacks consistent solutions. The method of decomposing the geometric constraint equations into a first subset which possesses consistent solutions and a second subset which lacks consistent solutions is well known to those skilled in the art.

In block 716, system 200 may optionally receive instructions from a user identifying one or more geometric elements in the second subset (referred to herein as the “third subset”) to be satisfied exactly and not be included in the numerical approximation methods analysis. In block 720, system 200 computes the consistent solutions of the first and third subsets of geometric constraint equations. Thus, the geometric elements of the first and third subsets are computed consistently using mathematical operations of addition, subtraction and square root.

In block 724, system 200 computes approximate numerical solutions of the second subset. According to disclosed embodiments, the geometric elements of the second subset are computed by applying a numerical least squares minimization algorithm. This algorithm minimizes the sum of the squares of the residuals of the equations of the second subset. In block 728, system 200 stores the consistent solutions and the approximate numerical solutions in a storage device. The consistent solutions and the approximate numerical solutions may be used to create the virtual model which may be displayed graphically on a monitor connected to system 200.

According to disclosed embodiments, the first subset of dimensional constraint equations is represented by first polynomials, wherein the consistent solutions of the first subset are represented by consistent solutions of the first polynomials. According to disclosed embodiments, the second subset is represented by second polynomials, wherein the approximate numerical solutions of the second subset are computed by minimizing least squares of the second polynomials. The consistent solutions and the approximate numerical solutions may be stored in a storage device connected to system 200.

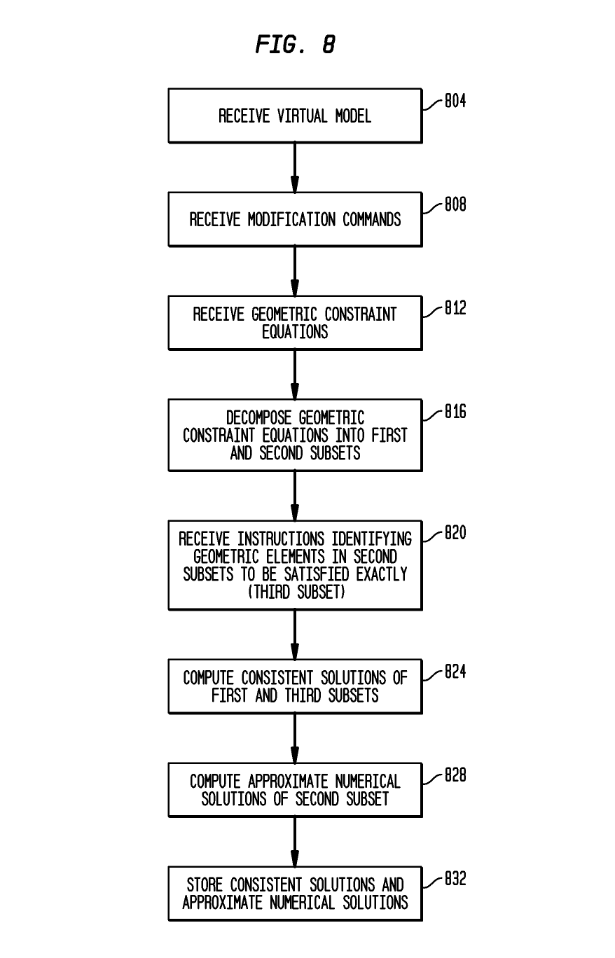

FIG. 8 is a flowchart of a process according to disclosed embodiments. Such a process can be performed, for example, by system 200 as described above, but the “system” in the process below can be any apparatus configured to perform a process as described. In block 804, system 200 receives a virtual model. In block 808, system 200 receives modification commands from a user. The modification commands may, for example, specify changes to one or more geometric elements of the virtual model. In block 812, system 200 receives geometric constraint equations of the virtual model. The geometric constraint equations reflect changes to the virtual model caused by the modification commands. As described before, the geometric constraint equations may be generated by a CAD application.

In block 816, system 200 decomposes the geometric constraint equations into a plurality of first and second subsets of the geometric constraint equations. The first subset possesses consistent solutions but the second subset lacks consistent solutions. The method of decomposing the geometric constraint equations into a first subset which possesses consistent solutions and a second subset which lacks consistent solutions is well known to those skilled in the art.

In block 820, system 200 optionally receives instructions from a user identifying one or more geometric elements in the second subset (referred to herein as the “third subset”) to be satisfied exactly and not be included in the numerical methods analysis. In block 824, system 200 computes the consistent solutions of the first and third subsets of geometric constraint equations. Thus, the geometric elements of the first and third subsets are computed consistently using mathematical operations of addition, subtraction and square root.

In block 828, system 200 computes approximate numerical solutions of the second subset. According to disclosed embodiments, the geometric elements of the second subset are computed by applying a numerical least squares minimization algorithm. In block 832, system 200 stores the consistent solutions and the approximate numerical solutions in a storage device. The consistent solutions and the approximate numerical solutions may be used to create the virtual model which may be displayed graphically on a monitor.

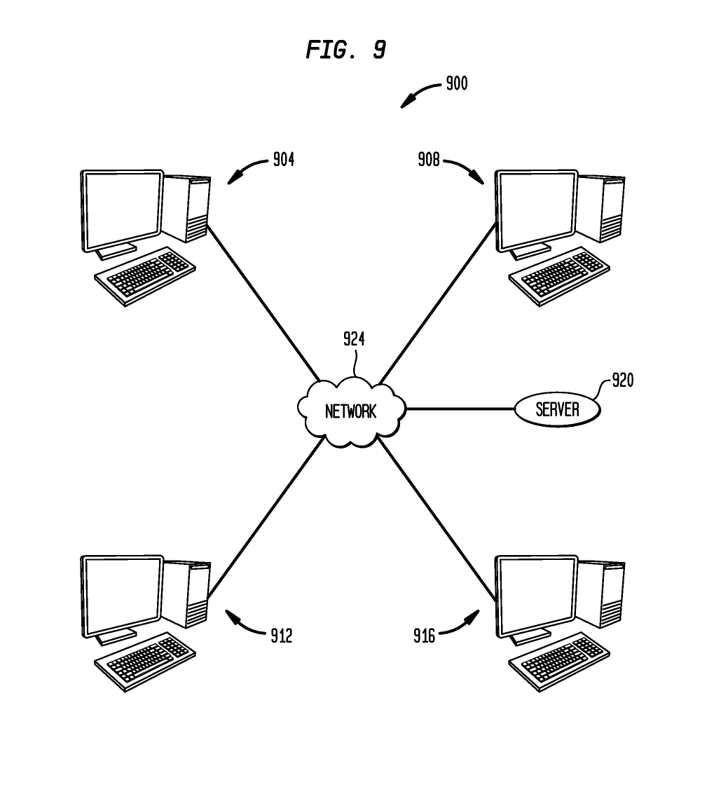

FIG. 9 illustrates a cloud computing system 900 according to disclosed embodiments. System 900 includes a plurality of workstations 904-916 linked to server 920 via a communication network such as the Internet 824. Server 920 may be implemented as system 200, which enables workstations 904-916 to create a virtual model. Server 920 may be configured to compute solutions of geometric constraints of the virtual model, which may be stored in server 920.

According to disclosed embodiments, a non-transitory computer-readable medium is encoded with computer-executable instructions for computing solutions of geometric constraint equations of a computer-implemented virtual model. The computer-executable instructions when executed cause at least one data processing system to receive geometric constraint equations of the virtual model and to decompose the geometric constraint equations into a plurality of first and second subsets, wherein the first subset possesses consistent solutions and wherein the second subset lacks consistent solutions. The computer-executable instructions cause at least one data processing system to compute the consistent solutions of the first subset and to compute approximate numerical solutions of the second subset.

Those skilled in the art will recognize that, for simplicity and clarity, the full structure and operation of all systems suitable for use with the present disclosure is not being depicted or described herein. Instead, only so much of a system as is unique to the present disclosure or necessary for an understanding of the present disclosure is depicted and described. The remainder of the construction and operation of the disclosed systems may conform to any of the various current implementations and practices known in the art.

Of course, those of skill in the art will recognize that, unless specifically indicated or required by the sequence of operations, certain steps in the processes described above may be omitted, performed concurrently or sequentially, or performed in a different order. Further, no component, element, or process should be considered essential to any specific claimed embodiment, and each of the components, elements, or processes can be combined in still other embodiments.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A data processing system for computing solutions of geometric constraint equations of a computer-implemented virtual model, comprising:
at least one processor;
a memory connected to the processor, wherein the data processing system is configured to:
receive the virtual model;
receive the geometric constraint equations of the virtual model;
decompose the geometric constraint equations into first and second subsets of the geometric constraint equations, wherein the first subset possesses consistent solutions and wherein the second subset lacks consistent solutions;
compute the consistent solutions of the first subset;
compute approximate numerical solutions of the second subset by applying numerical methods to the second subset; and
store the algebraic solutions and the approximate numerical solutions in a storage device connected to the processor.

2. The data processing system of claim 1, wherein the geometric constraint equations represent geometric elements of the virtual model.

3. The data processing system of claim 1 further configured to:
receive modification commands specifying modifications to one or more geometric elements of the virtual model;
receive modified geometric constraint equations of the modified virtual model;
decompose the modified geometric constraint equations into first and second subsets, wherein the first subset possesses consistent solutions and wherein the second subset lacks consistent solutions;
compute the consistent solutions of the first subset;
compute approximate numerical solutions of the second subset by applying numerical methods to the second subset; and
store the consistent solutions and the approximate numerical solutions in a storage device.

4. The data processing system of claim 1 further configured to:
receive instructions identifying one or more geometric elements of the virtual model not be included in the numerical solution computation; and
compute consistent solutions of the geometric constraint equations corresponding to the identified geometric elements.

5. The data processing system of claim 2, wherein the consistent solutions provide numerical values associated with a first subset of the geometric elements.

6. The data processing system of claim 2, wherein the approximate numerical solutions provide numerical values associated with a second subset of the geometric elements.

7. The data processing system of claim 1, wherein the approximate numerical solutions are computed by minimizing the sum of the squares of the residuals of the second subset of geometric constraint equations.

8. The data processing system of claim 1, wherein the virtual model is created with the consistent solutions and the approximate numerical solutions.

9. The data processing system of claim 1, wherein the first subset of geometric constraint equations is represented by first polynomials, and wherein the algebraic solutions of the first subset are represented by consistent solutions of the first polynomials.

10. The data processing system of claim 1, wherein the second subset is represented by second polynomials, and wherein the approximate numerical solutions of the second subset are computed by minimizing the sum of the squares of the residuals of the second polynomials.

11. The data processing system of claim 9, wherein the first polynomials possess consistent solutions which are independent from the second polynomials.

12. The data processing system of claim 1, wherein the virtual model is graphically displayed on a monitor connected to the processor.

13. The data processing system of claim 1, wherein the consistent solutions and the approximate numerical solutions are stored in a storage device connected to the processor via a communication network.

14. A method for computing solutions of geometric constraint equations of a computer-implemented virtual model, comprising:
receiving the virtual model;
receiving the geometric constraint equations of the virtual model;
decomposing the geometric constraint equations into a plurality of first and second subsets, wherein the first subset possesses consistent solutions and wherein the second subset lacks consistent solutions;
computing the consistent solutions of the first subset;
computing approximate numerical solutions of the second subset by applying numerical approximation methods to the second subset; and
storing the consistent solutions and the approximate solutions in a storage device.

15. The method of claim 14, wherein the geometric constraint equations represent geometric elements of the virtual model.

16. The method of claim 14, further comprising:
receiving modification commands specifying modifications to one or more geometric elements of the virtual model;
receiving modified geometric constraint equations of the modified virtual model;
decomposing the modified geometric constraint equations into first and second subsets, wherein the first subset possesses consistent solutions and wherein the second subset lacks consistent solutions;
computing the consistent solutions of the first subset;
computing approximate numerical solutions of the second subset by applying numerical methods to the second subset; and
storing the consistent solutions and the approximate numerical solutions in a storage device.

17. The method of claim 14, further comprising:
receiving instructions identifying one or more geometric elements of the virtual model not be included in the numerical solution computation; and
computing consistent solutions of the geometric constraint equations corresponding to the identified geometric elements.

18. The method of claim 14, wherein the consistent solutions provide numerical values associated with a first subset of the geometric elements.

19. The method of claim 14, wherein the approximate numerical solutions provide numerical values associated with a second subset of the geometric elements.

20. The method of claim 14, further comprising minimizing the sum of the squares of the residuals of the second subset to compute the approximate numerical solutions.

21. The method of claim 14, further comprising creating the virtual model with the consistent solutions and the approximate numerical solutions.

22. A non-transitory computer-readable medium encoded with computer-executable instructions for computing approximate solutions of geometric constraint equations of a computer-implemented virtual model, wherein the computer-executable instructions when executed cause at least one data processing system to:
receive the virtual model;
receive the geometric constraint equations of the virtual model;
decompose the geometric constraint equations into first and second subsets, wherein the first subset possesses consistent solutions and wherein the second subset lacks consistent solutions;
compute the consistent solutions of the first subset;
compute approximate numerical solutions of the second subset by applying numerical methods to the second subset; and
store the consistent solutions and the approximate numerical solutions in a storage device.
